(19) United States
(12) Patent Application Publication
(10) Pub. No.: US 2023/0406285 A1
(43) Pub. Date: Dec. 21, 2023

(54) ROBUST GASOLINE PARTICULATE FILTER CONTROL WITH FULL CYLINDER DEACTIVATION

(71) Applicants: Ben T Dean, Rochester Hills, MI (US); Michael A Barkey, Maidstone (CA)

(72) Inventors: Ben T Dean, Rochester Hills, MI (US); Michael A Barkey, Maidstone (CA)

(21) Appl. No.: 17/825,676

(22) Filed: May 26, 2022

(51) Int. Cl. B60W 20/16; B60W 10/06; F01N 3/023; F02D 41/02; B60W 10/08; F02D 41/12; F01L 13/00; F02D 13/06; F01L 9/10; F01L 9/20; F01L 9/40

(52) U.S. Cl. CPC B60W 20/16; B60W 10/06; F01N 3/023; F02D 41/029; B60W 10/08; F02D 41/12; F01L 2013/001; F02D 13/06; F01L 9/10; F01L 9/20; F01L 9/40; B60W 2540/10; F01L 13/0005

(57) ABSTRACT

Hybrid powertrain control techniques include determining whether a regeneration event of a gasoline particulate filter (GPF) is necessary using a GPF loading model, commanding a full cylinder deactivation system to temporarily disable all of the cylinders of the engine instead of performing a deceleration fuel shutoff (DFSO) event of the engine and disabling fueling to the engine when the GPF regeneration event is not necessary, commanding the full cylinder deactivation system to keep all of the cylinders of the engine open and disabling fueling to the engine to perform the DFSO event when the GPF regeneration event is necessary, and controlling an electric propulsion motor to supply a requested drive torque, wherein keeping all of the cylinders of the engine open to perform the DFSO of the engine mitigates or eliminates insufficient regeneration of the GPF to thereby increase or extend its useful life.

### FIELD

The present application generally relates to gasoline particulate filters (GPFs) and, more particularly, to techniques for robust GPF control with full cylinder deactivation.

### BACKGROUND

Internal combustion engines generate emissions (gases, particulate matter, etc.) as a result of the combustion of a fuel/air mixture. Gasoline particulate filters (GPFs) are required emissions control devices in certain markets (e.g., Europe). A GPF works similar to a diesel particulate filter (DPF) in that it traps and stores particulate matter resulting from internal engine fuel/air combustion and is periodically regenerated to burn off the stored particulate matter. Regeneration typically occurs passively during deceleration fuel shutoff (DFSO). In hybrid powertrains, however, DFSO is typically minimized for peak fuel economy and emissions (through the periodic usage of electric propulsion motor(s)). Insufficient GPF regeneration over time reduces an efficiency of the GPF, which could render it less effective or inoperable over time and potentially increase warranty/replacement costs. Accordingly, while such conventional engine emissions control systems do work well for their intended purpose, there exists an opportunity for improvement in the relevant art.

### SUMMARY

According to one example aspect of the invention, a control system for a hybrid powertrain of a vehicle, the hybrid powertrain including an internal combustion gasoline engine with a gasoline particulate filter (GPF) and at least one electric propulsion motor, is presented. In one exemplary implementation, the control system comprises a full cylinder deactivation system configured to selectively disable all cylinders of the engine, and a controller configured to determine whether a regeneration event of the GPF is necessary using a GPF loading model, when the GPF regeneration event is not necessary, disable fueling to the engine and command the full cylinder deactivation system to temporarily disable all of the cylinders of the engine instead of performing a deceleration fuel shutoff (DFSO) event of the engine, when the GPF regeneration event is necessary, disable fueling to the engine and command the full cylinder deactivation system to keep all of the cylinders of the engine open to perform the DFSO event of the engine, and control the electric propulsion motor to supply requested drive torque, wherein keeping all of the cylinders of the engine open to perform the DFSO event of the engine mitigates or eliminates insufficient regeneration of the GPF to thereby increase or extend its useful life.

In some implementations, the full cylinder deactivation system is a hydraulic or electro-hydraulic cylinder valve control system. In some implementations, the full cylinder deactivation system is a mechanical sliding cam cylinder valve control system. In some implementations, the controller is configured to disable fueling to the engine in response to a driver torque request falling below a driver torque request threshold. In some implementations, the driver torque request threshold would otherwise cause the DFSO event of the engine. In some implementations, the vehicle is a hybrid or electrified utility vehicle (UV).

According to another example aspect of the invention, a control method for a hybrid powertrain of a vehicle, the hybrid powertrain including an internal combustion gasoline engine with a GPF and at least one electric propulsion motor is presented. In one exemplary implementation, the control method comprises determining, by a controller of the vehicle, whether a regeneration event of the GPF is necessary using a GPF loading model, commanding, by the controller, a full cylinder deactivation system to temporarily disable all of the cylinders of the engine instead of performing a DFSO event of the engine and disabling fueling to the engine when the GPF regeneration event is not necessary, commanding, by the controller, the full cylinder deactivation system to keep all of the cylinders of the engine open and disabling fueling to the engine to perform the DFSO event when the GPF regeneration event is necessary, and controlling, by the controller, the electric propulsion motor to supply requested drive torque, wherein keeping all of the cylinders of the engine open to perform the DFSO of the engine mitigates or eliminates insufficient regeneration of the GPF to thereby increase or extend its useful life.

In some implementations, the full cylinder deactivation system is a hydraulic or electro-hydraulic cylinder valve control system. In some implementations, the full cylinder deactivation system is a mechanical sliding cam cylinder valve control system. In some implementations, disabling fueling to the engine is performed by the controller in response to a driver torque request falling below a driver torque request threshold. In some implementations, the driver torque request threshold would otherwise cause the DFSO event of the engine. In some implementations, the vehicle is a hybrid or electrified UV.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having a hybrid powertrain with a gasoline particulate filter (GPF) and full cylinder deactivation (FCD) capability according to the principles of the present application; and

FIG. 2 is a flow diagram of an example hybrid powertrain control method for a vehicle having a GPF and full cylinder deactivation (FCD) capability according to the principles of the present application.

### DESCRIPTION

As previously discussed, insufficient gasoline particulate filter (GPF) regeneration over time could render the GPF less effective or inoperable over time, which could potentially increase warranty/replacement costs. As a result, improved emissions control systems and methods that leverage a vehicle's hybrid powertrain that comprises both an engine with a GPF and full cylinder deactivation (FCD) capability (hydraulic, sliding cams, electric, etc.) and an electric propulsion motor. Rather than minimizing DFSO for fuel economy and emissions optimization, instead of commanding FCD while the electric propulsion motor remains available to supply necessary drive torque, airflow could be allowed (with no fueling) to effectively perform a DFSO event and thereby regenerate the GPF when needed. By increasing the frequency of DFSO and GPF regeneration to a desired/necessary level, we can extend GPF useful life and potentially decrease warranty/replacement costs.

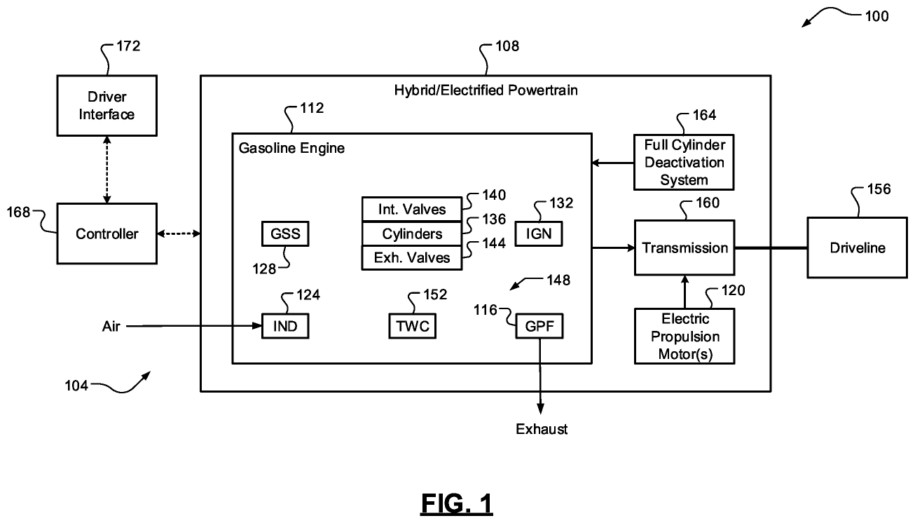

Referring now to FIG. 1, a functional block diagram of a hybrid or electrified vehicle 100 having a control system 104 for its hybrid powertrain 108 according to some implementations of the present application is illustrated. The hybrid powertrain 108 comprises an internal combustion gasoline engine 112 with a GPF 116 and at least one electric propulsion motor 120. The engine 112 further comprises an induction system (IND) 124, a gasoline supply system (GSS) 128, an ignition system (IGN) 132, a plurality of cylinders 136 each having a respective intake and exhaust valve 140, 144, and an exhaust system 148 that includes the GPF 116, which is typically downstream from other components of the exhaust system 148 such as a three-way catalytic converter (TWC) 152.

The engine 112 generally operates by drawing in air and combining the air with liquid gasoline from the gasoline supply system 128 (e.g., fuel tank, fuel pump, fuel rail, and fuel injectors) to create a gasoline/air mixture that is provided to each of the cylinders 136. This gasoline/air mixture is compressed by respective pistons (not shown) in the cylinders 136 and ignited by the ignition system 132 (e.g., respective spark plugs) to drive the pistons (not shown) and generate drive torque at a crankshaft (not shown) of the engine 112, which could then be transferred to a driveline 156 via a transmission 160 for vehicle propulsion. The electric propulsion motor(s) 120 are also configured to generate drive torque (e.g., in response to electrical energy or current supplied by a battery system, not shown) that can then be transferred via the transmission 160 or applied directly at the driveline 156 for vehicle propulsion. Due to recent improvements in electric propulsion motor technology, electric propulsion motors can be sufficient for vehicle propulsion, including larger vehicles such as utility vehicles (UVs, such as sport UVs, or SUVs).

The engine 112 also comprises a full cylinder deactivation (FCD) system 164 configured to selectively disable all cylinders 136 of the engine 112, which could be in conjunction with disabling fueling and preventing airflow therethrough (FCD) or disabling fueling and allowing airflow therethrough (DFSO). Any suitable configuration for the full cylinder deactivation system 164 could be implemented, including, but not limited to, hydraulic valve control, electro-hydraulic valve control, and mechanical (e.g., sliding cam) valve control. More specifically, this full deactivation of all of the cylinders 136 of the engine 112 comprises actuating and holding the intake and exhaust valves 140, 144 in closed positions such that no air/exhaust flows through the engine 112 and through the exhaust system 148, which, as previously discussed herein, could cause passive regeneration of the GPF 116. The GPF 116 generally comprises a honeycomb filter structure of ceramic(s) or precious metal(s) housed inside a housing (e.g., a metal container).

As exhaust gas passes through the GPF 116, the honeycomb filter structure traps excess nitrous oxide, carbon monoxide, and hydrocarbon particulate matter. In contrast to diesel engines and diesel particulate filters (DPFs), hydrocarbon particulate matter is much smaller (e.g., 100 times less in size) and the higher operating temperatures (exhaust gas temperatures) in gasoline engines more efficiently burns off the trapped particulate matter in the GPF 116 (e.g., 90-95% reduction in hydrocarbon particulate matter), although it is still capable of getting full/clogged and thus does need regeneration from time to time. Regeneration refers to a passive or active (intrusive) period during which the exhaust gas temperature increases to such a high level that it “lights off” or otherwise initiates a burn event that should burn off most or all of the trapped hydrocarbon particulate matter. As previously discussed herein, GPFs are very expensive devices and thus any means by which their lives can be extended can drastically reduce warranty/replacement costs.

A controller 168 is configured to control the powertrain 108, including controlling the powertrain 108 to generate a desired amount of drive torque to satisfy a driver torque request provided via a driver interface 172 (e.g., an accelerator pedal). The controller 168 is also configured to perform at least a portion of the powertrain control techniques of the present application, which will now be discussed in greater detail. During some operation scenarios (e.g., driver torque request above a driver torque request threshold), the engine 112 is running and the full cylinder deactivation system 164 has disabled none or only some of the cylinders 136 (partial cylinder operation mode). During these periods, the electric propulsion motor(s) 120 could be operating as torque generators to provide additional drive torque or could alternatively be operating as torque consumers (i.e., drawing off at least a portion of the drive torque generated by the engine 112 to generate electrical energy, such as for recharging the battery system (not shown) and/or for powering electrical accessory loads (e.g., a heating/ventilation/cooling, or HVAC system (not shown) of the vehicle 100).

When the driver torque request falls below the driver torque request threshold or another suitable driver torque request threshold, the engine 112 would normally be commanded by the controller 168 to perform a temporary FCD event. This FCD event includes fueling to the engine 112 being temporarily disabled while also preventing air/exhaust gas therethrough and through the exhaust system 148. As previously discussed, this could potentially prevent a necessary regeneration event of the GPF 116, which is undesirable if repeated unnecessarily over time as it can reduce the useful life of the GPF 116 and thereby potentially increase warranty/replacement costs for the vehicle 100.

Therefore, instead of commanding the FCD event of the engine 112, the controller 168 instead commands a DFSO event where fueling to the engine 112 is temporarily disabled and the full cylinder deactivation system 164 to keeps the intake/exhaust valves 140, 144 of the engine 112 open, thereby allowing the flow of air/exhaust gas therethrough and the exhaust system 148. During this period, the controller 168 also controls the electric propulsion motor(s) 120 to provide the requested drive torque to meet the driver torque request. As previously discussed, however, this could include such a low driver torque request (e.g., zero or approximately zero) such that the electric propulsion motor(s) 120 could operate as torque consumers to recapture otherwise wasted kinetic energy and also provide the expected deceleration feel to the driver (i.e., an expected coast-down effect or feel).

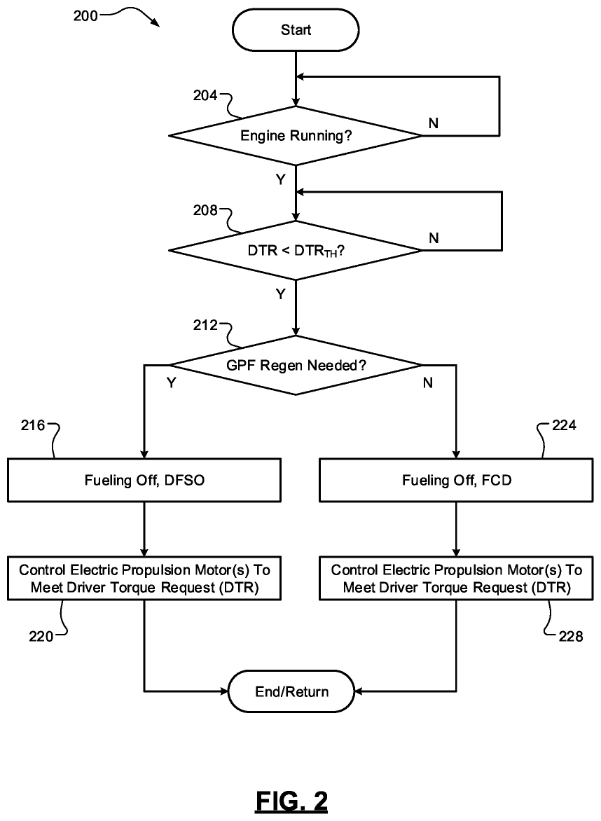

Referring now to FIG. 2, a flow diagram of an example hybrid powertrain control method 200 for a vehicle having a GPF and full cylinder deactivation capability according to the principles of the present application. While the vehicle 100 and its components (engine 112, GPF 116, motor(s) 120, etc.) are specifically referenced for explanatory purposes, it will be appreciated that this control method 200 could be applicable to any suitable hybrid or electrified vehicle having an engine with a GPF and full cylinder deactivation capability and at least one electric propulsion motor. At 204, the controller 168 determines whether the engine 112 is running (partial or full cylinder operation modes). When true, the method 200 proceeds to 208. Otherwise, the method 200 ends or returns to 204.

At 208, the controller 168 determines whether the driver torque request (DTR) falls below a driver torque request threshold (DTRTH) that would otherwise trigger a DFSO event of the engine 112. When true, the method 200 proceeds to 212. Otherwise, the method 200 returns to 208. At 212, the controller 168 determines whether regeneration of the GPF 116 is necessary (e.g., based on a GPF loading model). This GPF loading model could utilize other measured and/or known parameters (fuel/air (FA) ratio, combustion ratio, air/exhaust mass flow, etc.) to model or otherwise estimate a load (e.g., an amount of particulate matter) currently trapped by the GPF 116. When true, the method proceeds to 216. Otherwise, the method proceeds to 224. At 216, the controller 168 turns off (disables fueling to) the engine 112 and commands the full cylinder deactivation system to keep open cylinder valves (a DFSO event) to allow airflow therethrough to initiate the necessary GPF regeneration event. At 220, the controller 168 controls the electric propulsion motor(s) 120 to operate as torque generators or torque consumers to achieve the desired drive torque specified by the driver torque request.

The method 200 then ends or returns to 204 for another cycle. At 224, the controller 168 turns off (disables fueling to) the engine 112 and commands the full cylinder deactivation system 164 to temporarily disable all of the cylinders 136 of the engine 112 (a full FCD event) instead of performing a DFSO event to mitigate or eliminate passive regeneration of the GPF 116. At 228, the controller 168 controls the electric propulsion motor(s) 120 to operate as torque generators or torque consumers to achieve the desired drive torque specified by the driver torque request. The method 200 then ends or returns to 204 for another cycle, such as when the driver torque request increases again and the engine 112 is commanded to restart with open/enabled cylinders 136 via the full cylinder deactivation system 164 (partial or full cylinder modes).

It will be appreciated that the term “controller” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

1. A control system for a hybrid powertrain of a vehicle, the hybrid powertrain including an internal combustion gasoline engine with a gasoline particulate filter (GPF) and at least one electric propulsion motor, the control system comprising:
a cylinder deactivation system configured to selectively disable all cylinders of the engine; and
a controller configured to (i) determine a driver torque request for the vehicle, (ii) control the electric propulsion motor to satisfy the driver torque request, and (iii) shut off the engine by:
determining whether a regeneration event of the GPF is necessary based on a GPF loading model having an input of a period that the electric propulsion motor and not the engine has been satisfying the driver torque request;
when the GPF regeneration event is not necessary, shutting off the engine by disabling fueling to the engine and commanding the cylinder deactivation system to temporarily disable all of the cylinders of the engine; and
when the GPF regeneration event is necessary, shutting off the engine by disabling fueling to the engine and commanding the cylinder deactivation system to keep all of the cylinders of the engine to increase oxygen levels at the GPF to improve passive regeneration of the GPF.

2. The control system of claim 1, wherein the cylinder deactivation system is a hydraulic or electro-hydraulic cylinder valve control system.

3. The control system of claim 1, wherein the cylinder deactivation system is a mechanical sliding cam cylinder valve control system.

4. The control system of claim 1, wherein when the engine is running and satisfying at least a portion of the driver torque request, the controller is further configured to control the engine to by disabling fueling to the engine in response to the driver torque request falling below a driver torque request threshold.

5. The control system of claim 4, wherein the driver torque request threshold is associated with a deceleration fuel shutoff (DFSO) event of the engine.

6. The control system of claim 1, wherein the vehicle is a hybrid or electrified utility vehicle (UV).

7. A control method for a hybrid powertrain of a vehicle, the hybrid powertrain including an internal combustion gasoline engine with a gasoline particulate filter (GPF) and at least one electric propulsion motor, the control method comprising:
determining, by a controller of the vehicle, a driver torque request indicative of an amount of drive torque to be collectively provided by the electric propulsion motor and the engine for propulsion of the vehicle;
controlling, by the controller, the electric propulsion motor to satisfy the driver torque request; and
shutting down, by the controller, the engine by:
determining whether a regeneration event of the GPF is necessary based on a GPF loading model having an input of a period that the electric propulsion motor and not the engine has been satisfying the driver torque request;
commanding a cylinder deactivation system to temporarily disable all of the cylinders of the engine and disabling fueling to the engine when the GPF regeneration event is not necessary; and
commanding the cylinder deactivation system to keep all of the cylinders of the engine open and disabling fueling to the engine to increase oxygen levels at the GPF to improve passive regeneration of the GPF when the GPF regeneration event is necessary.

8. The control method of claim 7, wherein the cylinder deactivation system is a hydraulic or electro-hydraulic cylinder valve control system.

9. The control method of claim 7, wherein the cylinder deactivation system is a mechanical sliding cam cylinder valve control system.

10. The control method of claim 7, wherein when the engine is running and satisfying at least a portion of the driver torque request, the method further comprises controlling, by the controller, the engine by disabling fueling to the engine in response to the driver torque request falling below a driver torque request threshold.

11. The control method of claim 10, wherein the driver torque request threshold is associated with a deceleration fuel shutoff (DFSO) event of the engine.

12. The control method of claim 7, wherein the vehicle is a hybrid or electrified utility vehicle (UV).
